(19) United States
(12) Patent Application Publication
(10) Pub. No.: US 2020/0148024 A1
(43) Pub. Date: May 14, 2020

(54) VEHICLE AIR-CONDITIONING DEVICE

(71) Applicant: SANDEN AUTOMOTIVE CLIMATE SYSTEMS CORPORATION, Isesaki-shi, Gunma (JP)

(72) Inventors: Tetsuya ISHIZEKI, Isesaki-shi, Gunma (JP); Ryo MIYAKOSHI, Isesaki-shi, Gunma (JP); Kohei YAMASHITA, Isesaki-shi, Gunma (JP)

(21) Appl. No.: 16/634,777

(22) PCT Filed: Jul. 12, 2018
(86) PCT No.: PCT/JP2018/027201

§ 371 Date: Jan. 28, 2020

(30) Foreign Application Priority Data
Aug. 9, 2017 (JP) 2017-154156

(51) Int. Cl. B60H 1/00; B60H 1/22

(52) U.S. Cl. CPC B60H 1/0005; B60H 1/00328; B60H 1/00071; B60H 1/22; B60H 2001/0015; B60H 1/00007; B60H 2001/00185; B60H 2001/00114; B60H 1/00385

(57) ABSTRACT

Comfortable vehicle interior air conditioning is realized while giving an appropriate temperature difference to air blown out from outlets. A vehicle air-conditioning device 1 includes an air mix damper 28, a FOOT outlet 29A, and a VENT outlet 29B. A control device has a B/L mode to blow out air from both of the FOOT outlet and the VENT outlet to a vehicle interior. In the B/L mode, the control device sets a target air volume ratio TGSW to be within a predetermined intermediate range of an air volume ratio SW by the air mix damper, and calculates a target heater temperature TCO on the basis of a target outlet temperature TAO and the target air volume ratio TGSW.

### TECHNICAL FIELD

The present invention relates to a vehicle air-conditioning device which conditions air in a vehicle interior of a vehicle.

### BACKGROUND ART

Due to actualization of environmental problems in recent years, hybrid cars and electric vehicles have spread. Then, as an air conditioning device which is applicable to such a vehicle, there has been developed one which includes an electric compressor to compress and discharge a refrigerant, a radiator (condenser) provided within an air flow passage to let the refrigerant radiate heat, a heat absorber (evaporator) provided within the air flow passage to let the refrigerant absorb heat, and an outdoor heat exchanger provided outside a vehicle interior to let the refrigerant radiate heat or absorb heat, and which changes and executes respective operation modes such as a heating mode to let the refrigerant discharged from the compressor radiate heat in the radiator and let the refrigerant from which the heat has been radiated in this radiator absorb heat in the outdoor heat exchanger, a dehumidifying and heating mode to let the refrigerant discharged from the compressor radiate heat in the radiator and let the refrigerant from which the heat has been radiated absorb heat in the heat absorber and the outdoor heat exchanger, a dehumidifying and cooling mode to let the refrigerant discharged from the compressor radiate heat in the radiator and the outdoor heat exchanger and let the refrigerant from which the heat has been radiated absorb heat in the heat absorber, a cooling mode to let the refrigerant discharged from the compressor radiate heat in the outdoor heat exchanger and let the refrigerant absorb heat in the heat absorber, etc.

Then, an air mix damper is provided within the air flow passage, and the ratio of air to be passed through the radiator is adjusted from zero in a whole range by the air mix damper, whereby a target outlet temperature to the vehicle interior has been realized (refer to, for example, Patent Document 1).

In this case, the interior of the air flow passage on the leeward side of the heat absorber is partitioned into a heating heat exchange passage and a bypass passage, and the radiator is disposed in the heating heat exchange passage. Then, the air volume of the air to be passed through the heating heat exchange passage is adjusted by the air mix damper, but a parameter called an air volume ratio SW at which the air is to be passed through the heating heat exchange passage (radiator), which is obtained from a calculation formula of SW=(TAO−Te)/(TH−Te), is used for control of the air mix damper in this case.

Here, TAO is a target outlet temperature, TH is a temperature of the air on the leeward side of the radiator, and Te is a temperature of the heat absorber. The air volume ratio SW is calculated in a range of 0≤SW≤1. “0” has been defined to be an air mix fully-closed state in which the air is not passed through the heating heat exchange passage (radiator), and “1” has been defined to be an air mix fully-opened state in which all the air in the air flow passage is passed through the heating heat exchange passage (radiator).

### CITATION LIST

### Patent Documents

Patent Document 1: Japanese Patent Application Publication No. 2012-250708
Patent Document 2: Japanese Patent Application Publication No. 2014-54932

### SUMMARY OF THE INVENTION

### Problems to be Solved by the Invention

Here, respective outlets of FOOT (foot), VENT (vent), and DEF (def) are normally provided as outlets of air to a vehicle interior. The FOOT outlet is an outlet to blow out the air to the foot of the vehicle interior, and is located at the lowest position. Further, the VENT outlet is an outlet to blow out the air to the proximity of the breast or face of a driver in the vehicle interior, and is located above the FOOT outlet. Then, the DEF outlet is an outlet to blow out the air to an inner surface of a front glass, and is located at the highest position above other outlets.

Then, there are, in addition to a mode to blow out the air from any outlet of these, a B/L mode to blow out the air from both outlets of FOOT and VENT, an H/D mode to blow out the air from both outlets of FOOT and DET, etc. These are selected by manual or in an automatic mode, but from that purpose are constituted so that the air passed through the heating heat exchange passage (radiator) is easy to be blown out from the FOOT outlet, the air passed through the bypass passage is easy to be blown out from the DEF outlet, and the intermediate air between them is blown out from the VENT outlet.

Thus, when the aforementioned air volume ratio SW by the air mix damper is in an intermediate range, for example, the temperature of the air blown out from the FOOT outlet becomes higher than the air blown out from the VENT outlet in terms of its temperature, and the temperature of the air blown out from the VENT outlet becomes higher than the air blown out from the DEF outlet in terms of its temperature.

Therefore, for example, if the air volume ratio SW can be set to the intermediate range in the aforementioned B/L mode, a difference is made between the temperatures of the air blown out from the FOOT outlet and the VENT outlet, thereby making it possible to realize a temperature difference of so-called head-cold/feet-warm. Since, however, the air volume ratio SW changes according to such a calculation formula as described, a difficulty has occurred in setting the air volume ratio SW to the intermediate range while maintaining the outlet temperature.

On the other hand, there has also been developed a vehicle air-conditioning device which determines a heating means target temperature TAVO on the basis of an air mix door target valve position SW and a target outlet temperature TAO (refer to, for example, Patent Document 2).

The present invention has been developed in view of such conventional circumstances, and an object thereof is to realize comfortable vehicle interior air conditioning while providing a suitable difference in temperature between air blown out from outlets in a vehicle air-conditioning device.

### Means for Solving the Problems

A vehicle air-conditioning device of the present invention includes a compressor to compress a refrigerant, an air flow passage through which air to be supplied to a vehicle interior flows, a heater to heat the air to be supplied from the air flow passage to the vehicle interior, a heat absorber to let the refrigerant absorb heat, thereby cooling the air to be supplied from the air flow passage to the vehicle interior, a heating heat exchange passage and a bypass passage partitioned and formed in the air flow passage on a leeward side than the heat absorber, an air mix damper to adjust a ratio at which the air in the air flow passage passed through the heat absorber is to be passed through the heating heat exchange passage, a first outlet to blow out the air from the air flow passage to the vehicle interior, a second outlet to blow out the air from the air flow passage to the vehicle interior at a position above the first outlet, and a control device. The vehicle air-conditioning device is characterized in that the heater is disposed in the heating heat exchange passage, configured so that the air passed through the heating heat exchange passage is easy to be blown out from the first outlet than the second outlet and the air passed through the bypass passage is easy to be blown out from the second outlet than the first outlet, and in that the control device controls heating by the heater on the basis of a target heater temperature TCO being a target value of a heating temperature TH being a temperature of the air on a leeward side of the heater, calculates an air volume ratio SW of the air to be passed through the heating heat exchange passage on the basis of a target outlet temperature TAO being a target value of a temperature of the air blown out to the vehicle interior and the heating temperature TH to control the air mix damper, and further in that the control device has a first outlet mode to blow out the air from both of the first outlet and the second outlet to the vehicle interior, and in the first outlet mode, the control device sets a predetermined target air volume ratio TGSW to be within a predetermined intermediate range of the air volume ratio SW, and calculates the target heater temperature TCO on the basis of the target outlet temperature TAO and the target air volume ratio TGSW.

The vehicle air-conditioning device of the invention of claim 2 is characterized in that in the above invention, when it is given that SW=(TAO−Te)/(TH−Te) . . . (I),

where a temperature of the heat absorber is assumed to be Te, the control device calculates the air volume ratio SW in the above formula (I).

The vehicle air-conditioning device of the invention of claim 3 is characterized in that in the above invention, when it is given that TCO=(TAO−TEO)/TGSW+TEO . . . (II),

where a target heat absorber temperature being a target value of the temperature Te of the heat absorber is assumed to be TEO, the control device calculates the target heater temperature TCO in the above formula (II).

The vehicle air-conditioning device of the invention of claim 4 is characterized in that in the above invention, when it is given that TCO=2×TAO−TEO . . . (III),

the control device calculates the target heater temperature TCO in the above formula (III).

The vehicle air-conditioning device of the invention of claim 5 is characterized in that in the invention of claim 2, when it is given that TCO=(TAO−Te)/TGSW+Te . . . (IV), the control device calculates the target heater temperature TCO in the above formula (IV).

The vehicle air-conditioning device of the invention of claim 6 is characterized in that in the above invention, when it is given that TCO=2×TAO−Te . . . (V),

the control device calculates the target heater temperature TCO in the above formula (V).

The vehicle air-conditioning device of the invention of claim 7 is characterized in that in the above respective inventions, the heater is a radiator to let the refrigerant radiate heat to thereby heat the air to be supplied from the air flow passage to the vehicle interior, and/or an auxiliary heating device to heat the air to be supplied from the air flow passage to the vehicle interior.

### Advantageous Effect of the Invention

According to the present invention, in a vehicle air-conditioning device which includes a compressor to compress a refrigerant, an air flow passage through which air to be supplied to a vehicle interior flows, a heater to heat the air to be supplied from the air flow passage to the vehicle interior, a heat absorber to let the refrigerant absorb heat, thereby cooling the air to be supplied from the air flow passage to the vehicle interior, a heating heat exchange passage and a bypass passage partitioned and formed in the air flow passage on a leeward side than the heat absorber, an air mix damper to adjust a ratio at which the air in the air flow passage passed through the heat absorber is to be passed through the heating heat exchange passage, a first outlet to blow out the air from the air flow passage to the vehicle interior, a second outlet to blow out the air from the air flow passage to the vehicle interior at a position above the first outlet, and a control device, and in which the heater is disposed in the heating heat exchange passage, and the vehicle air-conditioning device is configured so that the air passed through the heating heat exchange passage is easy to be blown out from the first outlet than the second outlet and the air passed through the bypass passage is easy to be blown out from the second outlet than the first outlet, the control device controls heating by the heater on the basis of a target heater temperature TCO being a target value of a heating temperature TH being a temperature of the air on a leeward side of the heater, and calculates an air volume ratio SW of the air to be passed through the heating heat exchange passage on the basis of a target outlet temperature TAO being a target value of a temperature of the air blown out to the vehicle interior and the heating temperature TH to control the air mix damper, and further the control device has a first outlet mode to blow out the air from both of the first outlet and the second outlet to the vehicle interior, and in the first outlet mode, sets a predetermined target air volume ratio TGSW to be within a predetermined intermediate range of the air volume ratio SW, and calculates the target heater temperature TCO on the basis of the target outlet temperature TAO and the target air volume ratio TGSW. Therefore, in the first outlet mode, the target heater temperature TCO at which the air volume ratio SW calculated from the target outlet temperature TAO and the heating temperature TH falls within the predetermined intermediate range is calculated from the target outlet temperature TAO and the target air volume ratio TGSW, and heating by the heater is controlled based on the calculated target heater temperature TCO.

Thus, while maintaining the outlet temperature of the air to the vehicle interior, a sufficient difference in temperature is made between the air blown out from the first outlet and the air blown out from the second outlet in the first outlet mode, thereby making it possible to smoothly realize comfortable vehicle interior air conditioning indicative of so-called “head-cold/feet-warm.

Here, when it is given that SW=(TAO−Te)/(TH−Te) . . . (I), where the temperature of the heat absorber is assumed to be Te as in the invention of claim 2, the control device calculates the air volume ratio SW in the above formula (I). At this time, when it is given that

TCO=(TAO−TEO)/TGSW+TEO (II),

where the target heat absorber temperature being the target value of the temperature Te of the heat absorber is assumed to be TEO as in the invention of claim 3, the control device calculates the target heater temperature TCO in the above formula (II), thereby making it possible to perform the calculation of an appropriate target heater temperature TCO.

Incidentally, if the target air volume ratio TGSW is set to, for example, 0.5 serving as the center of 0≤SW≤1 in advance, the above formula (II) is given as follows as in the invention of claim 4,

TCO=2×TAO−TEO (III),

and can also be simplified like the above formula (III).

Further, as in the invention of claim 5, when it is given that TCO=(TAO−Te)/TGSW+Te . . . (IV),

the control device can calculate an appropriate target heater temperature TCO even by calculating the target heater temperature TCO in the above formula (IV).

Incidentally, if the target air volume ratio TGSW is set to, for example, 0.5 serving as the center of 0≤SW≤1 in advance, the above formula (IV) is given as follows as in the invention of claim 6,

TCO=2×TAO−Te (V),

and can also be simplified like the above formula (V).

Then, the heater of each invention described above can be constituted of as in the invention of claim 7, a radiator to let the refrigerant radiate heat to thereby heat the air to be supplied from the air flow passage to the vehicle interior, or an auxiliary heating device to heat the air to be supplied from the air flow passage to the vehicle interior, or both of the radiator and the auxiliary heating device. The above respective inventions become extremely effective for such a vehicle air-conditioning device.

### BRIEF DESCRIPTION OF THE DRAWINGS

FIG. 1 is a constitutional view of a vehicle air-conditioning device of an embodiment to which the present invention is applied (Embodiment 1);

FIG. 2 is a block diagram of a control device of the vehicle air-conditioning device of FIG. 1;

FIG. 3 is a schematic diagram of an air flow passage of the vehicle air-conditioning device of FIG. 1;

FIG. 4 is a control block diagram concerning compressor control in a heating mode of a heat pump controller of FIG. 2;

FIG. 5 is a control block diagram concerning compressor control in a dehumidifying and heating mode of the heat pump controller of FIG. 2;

FIG. 6 is a control block diagram concerning auxiliary heater (auxiliary heating device) control in the dehumidifying and heating mode of the heat pump controller of FIG. 2;

FIG. 7 is a diagram describing a relation between an air volume ratio SW, an outlet temperature from a FOOT outlet, and an outlet temperature from a VENT outlet;

FIG. 8 is a diagram describing calculation control of a target heater temperature TCO by the heat pump controller of FIG. 2; and

FIG. 9 is a constitutional view of a vehicle air-conditioning device of another embodiment of the present invention (Embodiment 2).

### MODE FOR CARRYING OUT THE INVENTION

Hereinafter, description will be made as to embodiments of the present invention in detail with reference to the drawings.

### Embodiment 1

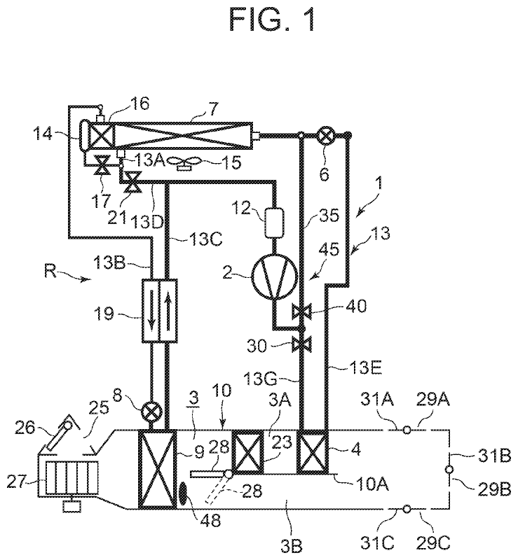

FIG. 1 shows a constitutional view of a vehicle air-conditioning device 1 of an embodiment of the present invention. A vehicle of the embodiment to which the present invention is applied is an electric vehicle (EV) in which an engine (an internal combustion engine) is not mounted, and runs with an electric motor for running which is driven by power charged in a battery (both being not shown in the drawing), and the vehicle air-conditioning device 1 of the present invention is also driven by the power of the battery. That is, in the electric vehicle which is not capable of performing heating by engine waste heat, the vehicle air-conditioning device 1 of the embodiment performs a heating mode by a heat pump operation in which a refrigerant circuit is used. Further, the vehicle air-conditioning device 1 selectively executes respective operation modes of a dehumidifying and heating mode, a dehumidifying and cooling mode, a cooling mode, a MAX cooling mode (maximum cooling mode), and an auxiliary heater single mode.

Incidentally, the vehicle is not limited to the electric vehicle, and the present invention is also effective for a so-called hybrid car in which the engine is used together with the electric motor for running. Further, it is needless to say that the present invention is also applicable to a usual car which runs with the engine.

The vehicle air-conditioning device 1 of the embodiment performs air conditioning (heating, cooling, dehumidifying, and ventilation) of a vehicle interior of the electric vehicle. An electric type of compressor 2 to compress a refrigerant, a radiator 4 as a heater provided in an air flow passage 3 of an HVAC unit 10 in which air in the vehicle interior is ventilated and circulated, to let the high-temperature high-pressure refrigerant discharged from the compressor 2 flow therein via a refrigerant pipe 13G and to let the refrigerant radiate heat to heat the air supplied to the vehicle interior, an outdoor expansion valve 6 (a pressure reducing unit) constituted of an electric valve which decompresses and expands the refrigerant during the heating, an outdoor heat exchanger 7 which is provided outside the vehicle interior and which performs heat exchange between the refrigerant and the outdoor air to function as the radiator during the cooling and to function as an evaporator during the heating, an indoor expansion valve 8 (a pressure reducing unit) constituted of an electric valve to decompress and expand the refrigerant, a heat absorber 9 provided in the air flow passage 3 to let the refrigerant absorb heat during the cooling and dehumidifying to cool the air to be sucked from outside the vehicle interior and supplied to the vehicle interior, an accumulator 12, and others are successively connected by a refrigerant pipe 13, whereby a refrigerant circuit R is constituted.

Then, the refrigerant circuit R is filled with a predetermined amount of refrigerant and oil for lubrication. Incidentally, an outdoor blower 15 is provided in the outdoor heat exchanger 7. The outdoor blower 15 forcibly passes the outdoor air through the outdoor heat exchanger 7 to thereby perform the heat exchange between the outdoor air and the refrigerant, whereby the outdoor air is made to pass through the outdoor heat exchanger 7 even during stopping of the vehicle (i.e., its velocity is 0 km/h).

Further, the outdoor heat exchanger 7 has a receiver drier portion 14 and a subcooling portion 16 successively on a refrigerant downstream side. A refrigerant pipe 13A extending out from the outdoor heat exchanger 7 is connected to the receiver drier portion 14 via a solenoid valve 17 to be opened during the cooling. A refrigerant pipe 13B on an outlet side of the subcooling portion 16 is connected to an inlet side of the heat absorber 9 via the indoor expansion valve 8. Incidentally, the receiver drier portion 14 and the subcooling portion 16 structurally constitute a part of the outdoor heat exchanger 7.

Additionally, the refrigerant pipe 13B between the subcooling portion 16 and the indoor expansion valve 8 is provided in a heat exchange relation with a refrigerant pipe 13C on an outlet side of the heat absorber 9, and both the pipes constitute an internal heat exchanger 19. Consequently, the refrigerant flowing into the indoor expansion valve 8 through the refrigerant pipe 13B is made to be cooled (subcooled) by the low-temperature refrigerant flowing out from the heat absorber 9.

In addition, the refrigerant pipe 13A extending out from the outdoor heat exchanger 7 branches to a refrigerant pipe 13D, and this branching refrigerant pipe 13D communicates and connects with the refrigerant pipe 13C on a downstream side of the internal heat exchanger 19 via a solenoid valve 21 to be opened during the heating. The refrigerant pipe 13C is connected to the accumulator 12, and the accumulator 12 is connected to a refrigerant suction side of the compressor 2. Further, a refrigerant pipe 13E on an outlet side of the radiator 4 is connected to an inlet side of the outdoor heat exchanger 7 via the outdoor expansion valve 6.

Furthermore, a solenoid valve 30 (constituting a flow passage changing device) to be closed during dehumidifying and heating and MAX cooling to be described later is interposed in the refrigerant pipe 13G between a discharge side of the compressor 2 and an inlet side of the radiator 4. In this case, the refrigerant pipe 13G branches to a bypass pipe 35 on an upstream side of the solenoid valve 30. This bypass pipe 35 communicates and connects with the refrigerant pipe 13E on a downstream side of the outdoor expansion valve 6 via a solenoid valve 40 (also constituting a flow passage changing device) to be opened during the dehumidifying and heating and the MAX cooling. A bypass device 45 is constituted of these bypass pipe 35, solenoid valve 30 and solenoid valve 40.

The bypass device 45 is constituted of such a bypass pipe 35, a solenoid valve 30 and a solenoid valve 40 to thereby make it possible to smoothly perform changing of the dehumidifying and heating mode and the MAX cooling mode to allow the refrigerant discharged from the compressor 2 to directly flow in the outdoor heat exchanger 7, and the heating mode, the dehumidifying and cooling mode and the cooling mode to allow the refrigerant discharged from the compressor 2 to flow in the radiator 4, as will be described later.

Additionally, in the air flow passage 3 on an air upstream side of the heat absorber 9, respective suction ports of an outdoor air suction port and an indoor air suction port are formed (represented by a suction port 25 in FIG. 1). A suction changing damper 26 which changes the air introduced into the air flow passage 3 to indoor air (an indoor air circulating mode) being the air in the vehicle interior and outdoor air (an outdoor air introducing mode) being the air outside the vehicle interior is provided in the suction port 25. Further, an indoor blower (a blower fan) 27 for supplying the introduced indoor air and outdoor air to the air flow passage 3 is provided on an air downstream side of the suction changing damper 26.

Furthermore, in FIG. 1, 23 denotes an auxiliary heater as an auxiliary heating device (as another heater) provided in the vehicle air-conditioning device 1 of the embodiment. The auxiliary heater 23 of the embodiment is constituted of a PTC heater being an electric heater and provided in the air flow passage 3 on a windward side (an air upstream side) of the radiator 4 to the flow of the air in the air flow passage 3. Then, when the auxiliary heater 23 is energized to generate heat, the air in the air flow passage 3 flowing into the radiator 4 via the heat absorber 9 is heated. That is, the auxiliary heater 23 becomes a so-called heater core to perform heating of the vehicle interior or complement it. In the embodiment, the aforementioned radiator 4 and the auxiliary heater 23 become a heater.

Here, the air flow passage 3 on a leeward side (an air downstream side) more than the heat absorber 9 of the HVAC unit 10 is partitioned by a partition wall 10A to form a heating heat exchange passage 3A and a bypass passage 3B to bypass it. The aforementioned radiator 4 and auxiliary heater 23 are disposed in the heating heat exchange passage 3A.

Additionally, in the air flow passage 3 on a windward side of the auxiliary heater 23, there is provided an air mix damper 28 to adjust a ratio at which the air (the indoor air or outdoor air) in the air flow passage 3 flowing into the air flow passage 3 and passed through the heat absorber 9 is to be passed through the heating heat exchange passage 3A in which the auxiliary heater 23 and the radiator 4 are disposed.

Furthermore, the HVAC unit 10 on a leeward side of the radiator 4 is formed with respective outlets of a FOOT (foot) outlet 29A (first outlet), a VENT (vent) outlet 29B (a second outlet relative to the FOOT outlet 29A, and a first outlet relative to a DEF outlet 29C), and the DEF (def) outlet 29C (a second outlet). The FOOT outlet 29A is an outlet to blow out the air to the foot of the vehicle interior and is located at the lowest position. Further, the VENT outlet 29B is an outlet to blow out the air to the proximity of the breast or face of a driver in the vehicle interior, and is located above the FOOT outlet 29A. Then, the DEF outlet 29C is an outlet to blow out the air to an inner surface of a front glass of the vehicle, and is located at the highest position above other outlets 29A and 29B.

Then, the FOOT outlet 29A, the VENT outlet 29B, and the DEF outlet 29C are respectively provided with a FOOT outlet damper 31A, a VENT outlet damper 31B, and a DEF outlet damper 31C to control a blow-out amount of the air.

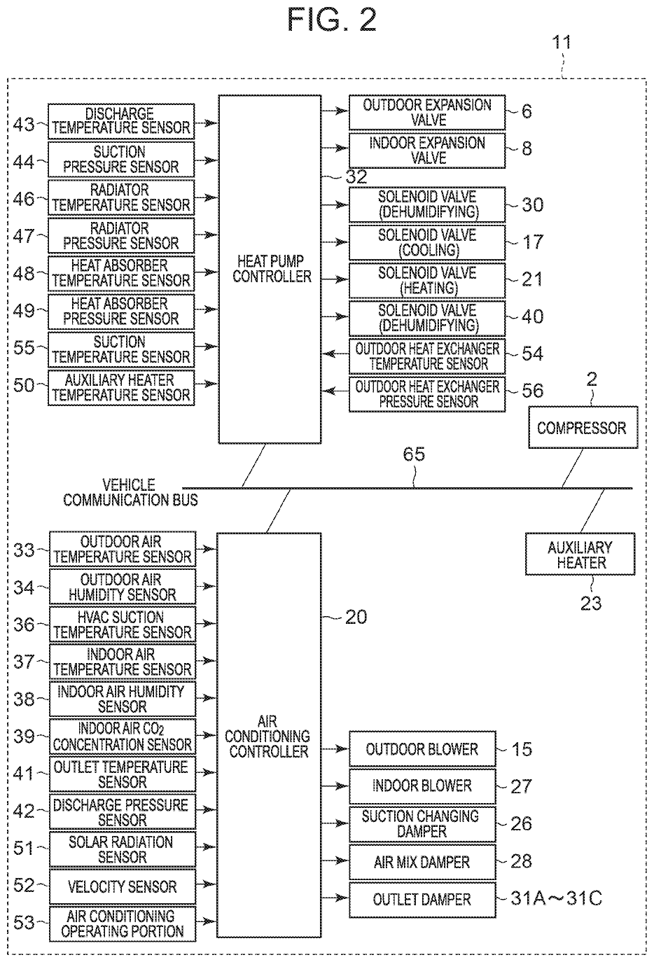

Next, FIG. 2 shows a block diagram of a control device 11 of the vehicle air-conditioning device 1 of the embodiment. The control device 11 is constituted of an air conditioning controller 20 and a heat pump controller 32 both constituted of a microcomputer as an example of a computer having a processor. These are connected to a vehicle communication bus 65 which constitutes a CAN (Controller Area Network) or a LIN (Local Interconnect Network). Further, the compressor 2 and the auxiliary heater 23 are also connected to the vehicle communication bus 65. These air conditioning controller 20, heat pump controller 32, compressor 2 and auxiliary heater 23 are constituted to perform transmission and reception of data through the vehicle communication bus 65.

The air conditioning controller 20 is a high-order controller which performs control of vehicle interior air conditioning of the vehicle. An input of the air conditioning controller 20 is connected with respective outputs of an outdoor air temperature sensor 33 which detects an outdoor air temperature (Tam), an outdoor air humidity sensor 34 which detects an outdoor air humidity, an HVAC suction temperature sensor 36 which detects a temperature (a suction air temperature Tas) of the air sucked from the suction port 25 to the air flow passage 3 and flowing into the heat absorber 9, an indoor air temperature sensor 37 which detects a temperature (an indoor air temperature Tin) of the air (the indoor air) of the vehicle interior, an indoor air humidity sensor 38 which detects a humidity of the air of the vehicle interior, an indoor air CO₂ concentration sensor 39 which detects a carbon dioxide concentration of the vehicle interior, an outlet temperature sensor 41 which detects a temperature of the air to be blown out to the vehicle interior, a discharge pressure sensor 42 which detects a discharge refrigerant pressure (a discharge pressure Pd) of the compressor 2, a solar radiation sensor 51 of, e.g., a photo sensor system to detect a solar radiation amount into the vehicle interior, and a velocity sensor 52 to detect a moving speed (a velocity) of the vehicle, and the air conditioning (aircon) operating portion 53 to set the changing of a predetermined temperature or the operation mode.

Further, an output of the air conditioning controller 20 is connected with the outdoor blower 15, the indoor blower (the blower fan) 27, the suction changing damper 26, the air mix damper 28, and the respective outlet dampers 31A through 31C, and they are controlled by the air conditioning controller 20.

The heat pump controller 32 is a controller which mainly performs control of the refrigerant circuit R. An input of the heat pump controller 32 is connected with respective outputs of a discharge temperature sensor 43 which detects a temperature of the refrigerant discharged from the compressor 2, a suction pressure sensor 44 which detects a pressure of the refrigerant to be sucked into the compressor 2, a suction temperature sensor 55 which detects a temperature of the refrigerant to be sucked into the compressor 2, a radiator temperature sensor 46 which detects a refrigerant temperature (a radiator temperature TCI) of the radiator 4, a radiator pressure sensor 47 which detects a refrigerant pressure (a radiator pressure PCI) of the radiator 4, a heat absorber temperature sensor 48 which detects a refrigerant temperature (a heat absorber temperature Te) of the heat absorber 9, a heat absorber pressure sensor 49 which detects a refrigerant pressure of the heat absorber 9, an auxiliary heater temperature sensor 50 which detects a temperature (an auxiliary heater temperature Tptc) of the auxiliary heater 23, an outdoor heat exchanger temperature sensor 54 which detects a refrigerant temperature (an outdoor heat exchanger temperature TXO) of the outdoor heat exchanger 7, and an outdoor heat exchanger pressure sensor 56 which detects a refrigerant pressure (an outdoor heat exchanger pressure PXO) of the outdoor heat exchanger 7.

Further, an output of the heat pump controller 32 is connected with the outdoor expansion valve 6, the indoor expansion valve 8, and respective solenoid valves of the solenoid valve 30 (for the dehumidification), the solenoid valve 17 (for the cooling), the solenoid valve 21 (for the heating), and the solenoid valve 40 (also for the dehumidification), and they are controlled by the heat pump controller 32. Incidentally, the compressor 2 and the auxiliary heater 23 respectively have controllers incorporated therein, and the controllers of the compressor 2 and the auxiliary heater 23 perform transmission and reception of data to and from the heat pump controller 32 via the vehicle communication bus 65 and are controlled by the heat pump controller 32.

The heat pump controller 32 and the air conditioning controller 20 mutually perform transmission and reception of the data via the vehicle communication bus 65 and control respective devices on the basis of the outputs of the respective sensors and the setting input by the air conditioning operating portion 53. However, in the embodiment in this case, the outputs of the outdoor air temperature sensor 33, the discharge pressure sensor 42, the velocity sensor 52, and the air conditioning operating portion 53 are transmitted from the air conditioning controller 20 to the heat pump controller 32 through the vehicle communication bus 65 and adapted to be supplied for control by the heat pump controller 32.

With the above constitution, an operation of the vehicle air-conditioning device 1 of the embodiment will next be described. In the embodiment, the control device 11 (the air conditioning controller 20 and the heat pump controller 32) changes and executes the respective operation modes of the heating mode, the dehumidifying and heating mode, the dehumidifying and cooling mode, the cooling mode, the MAX cooling mode (maximum cooling mode), and the auxiliary heater single mode. Description will initially be made as to an outline of a flow and control of the refrigerant in each operation mode.

(1) Heating Mode

When the heating mode is selected by the heat pump controller 32 (an automatic mode) or a manual operation (a manual mode) to the air conditioning operating portion 53, the heat pump controller 32 opens the solenoid valve 21 (for the heating) and closes the solenoid valve 17 (for the cooling). The heat pump controller 32 also opens the solenoid valve 30 (for the dehumidification) and closes the solenoid valve 40 (for the dehumidification). Then, the heat pump controller 32 operates the compressor 2. The air conditioning controller 20 operates the respective blowers 15 and 27, and the air mix damper 28 basically has a state of passing all the air in the air flow passage 3, which is blown out from the indoor blower 27 and then flows via the heat absorber 9, through the auxiliary heater 23 and the radiator 4 in the heating heat exchange passage 3A, but may adjust an air volume.

In consequence, a high-temperature high-pressure gas refrigerant discharged from the compressor 2 flows from the refrigerant pipe 13G into the radiator 4 via the solenoid valve 30. The air in the air flow passage 3 passes through the radiator 4, and hence the air in the air flow passage 3 is heated by the high-temperature refrigerant in the radiator 4 (by the auxiliary heater 23 and the radiator 4 when the auxiliary heater 23 operates). On the other hand, the refrigerant in the radiator 4 has the heat taken by the air and is cooled to condense and liquefy.

The refrigerant liquefied in the radiator 4 flows out from the radiator 4 and then flows through the refrigerant pipe 13E to reach the outdoor expansion valve 6. The refrigerant flowing into the outdoor expansion valve 6 is decompressed therein, and then flows into the outdoor heat exchanger 7. The refrigerant flowing into the outdoor heat exchanger 7 evaporates, and the heat is pumped up from the outdoor air passed by running or the outdoor blower 15. In other words, the refrigerant circuit R functions as a heat pump. Then, the low-temperature refrigerant flowing out from the outdoor heat exchanger 7 flows through the refrigerant pipe 13A, the solenoid valve 21, and the refrigerant pipe 13D, and flows from the refrigerant pipe 13C into the accumulator 12 to perform gas-liquid separation thereat, and thereafter the gas refrigerant is sucked into the compressor 2, thereby repeating this circulation. The air heated by the radiator 4 (the auxiliary heater 23 and the radiator 4 when the auxiliary heater 23 operates) is blown out from the respective outlets 29A through 29C, and hence the heating of the vehicle interior is performed.

The heat pump controller 32 calculates a target radiator pressure PCO (a target value of the radiator pressure PCI) from a target heater temperature TCO (a target value of the heating temperature TH to be described later) calculated based on a target outlet temperature TAO by the air conditioning controller 20, and controls the number of revolutions NC of the compressor 2 on the basis of the target radiator pressure PCO and the refrigerant pressure (the radiator pressure PCI that is a high pressure of the refrigerant circuit R) of the radiator 4 which is detected by the radiator pressure sensor 47 to control heating by the radiator 4. Further, the heat pump controller 32 controls a valve position of the outdoor expansion valve 6 on the basis of the temperature (the radiator temperature TCI) of the radiator 4 which is detected by the radiator temperature sensor 46 and the radiator pressure PCI detected by the radiator pressure sensor 47, and controls a subcool degree SC of the refrigerant in the outlet of the radiator 4.

Further, when the heating capability by the radiator 4 runs shorter than a heating capability required for vehicle-interior air conditioning in the heating mode, the heat pump controller 32 controls energization of the auxiliary heater 23 to complement its shortage by the generation of heat by the auxiliary heater 23. Thus, the comfortable heating of the vehicle interior is achieved and frosting of the outdoor heat exchanger 7 is also suppressed. At this time, since the auxiliary heater 23 is disposed on the air upstream side of the radiator 4, the air flowing through the air flow passage 3 passes through the auxiliary heater 23 before the radiator 4.

Here, when the auxiliary heater 23 is disposed on the air downstream side of the radiator 4, the temperature of the air flowing into the auxiliary heater 23 rises by the radiator 4 where the auxiliary heater 23 is constituted of the PTC heater as in the embodiment. Therefore, the resistance value of the PTC heater becomes large, and its current value is also reduced to lower the amount of heat generated therefrom. It is however possible to sufficiently exhibit the capability of the auxiliary heater 23 constituted of the PTC heater as in the embodiment by disposing the auxiliary heater 23 on the air upstream side of the radiator 4.

(2) Dehumidifying and Heating Mode

Next, in the dehumidifying and heating mode, the heat pump controller 32 opens the solenoid valve 17 and closes the solenoid valve 21. Further, the heat pump controller 32 closes the solenoid valve 30 and opens the solenoid valve 40, and fully closes the valve position of the outdoor expansion valve 6. Then, the heat pump controller 32 operates the compressor 2. The air conditioning controller 20 operates the respective blowers 15 and 27, and the air mix damper 28 basically has a state of passing all the air in the air flow passage 3, which is blown out from the indoor blower 27 and then flows via the heat absorber 9, through the auxiliary heater 23 and the radiator 4 in the heating heat exchange passage 3A, but performs an air volume adjustment as well.

Consequently, the high-temperature high-pressure gas refrigerant discharged from the compressor 2 to the refrigerant pipe 13G flows into the bypass pipe 35 without flowing to the radiator 4 and reaches the refrigerant pipe 13E on the downstream side of the outdoor expansion valve 6 through the solenoid valve 40. At this time, since the outdoor expansion valve 6 is fully closed, the refrigerant flows into the outdoor heat exchanger 7. The refrigerant flowing into the outdoor heat exchanger 7 is cooled by the running therein or the outdoor air to pass through the outdoor blower 15, to condense. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and reaches the indoor expansion valve 8 through the internal heat exchanger 19. After the refrigerant is decompressed in the indoor expansion valve 8, the refrigerant flows into the heat absorber 9 to evaporate. The air blown out from the indoor blower 27 is cooled by the heat absorbing operation at this time, and the water in the air coagulates to adhere to the heat absorber 9, and hence, the air in the air flow passage 3 is cooled and dehumidified. The refrigerant evaporated in the heat absorber 9 flows through the internal heat exchanger 19 to reach the accumulator 12 via the refrigerant pipe 13C, and is sucked into the compressor 2 therethrough, thereby repeating this circulation.

At this time, since the valve position of the outdoor expansion valve 6 is fully closed, it is possible to suppress or prevent the disadvantage that the refrigerant discharged from the compressor 2 reversely flows from the outdoor expansion valve 6 into the radiator 4. Thus, the lowering of a refrigerant circulation amount is suppressed or eliminated to enable an air conditioning capacity to be ensured. Further, in the dehumidifying and heating mode, the heat pump controller 32 energizes the auxiliary heater 23 to generate heat. Consequently, the air cooled and dehumidified in the heat absorber 9 is further heated in the process of passing through the auxiliary heater 23, and the temperature rises so that the dehumidifying and heating of the vehicle interior are performed.

The heat pump controller 32 controls the number of revolutions NC of the compressor 2 on the basis of a temperature (the heat absorber temperature Te) of the heat absorber 9 detected by the heat absorber temperature sensor 48 and a target heat absorber temperature TEO being a target value of the heat absorber temperature Te calculated by the air conditioning controller 20, and controls energization (heating by heat generation) of the auxiliary heater 23 on the basis of the auxiliary heater temperature Tptc detected by the auxiliary heater temperature sensor 50 and the aforementioned target heater temperature TCO, thereby appropriately preventing the lowering of a temperature of the air to be blown out from the respective outlets 29A through 29C to the vehicle interior by the heating by the auxiliary heater 23 while appropriately performing the cooling and dehumidifying of the air by the heat absorber 9. Consequently, it is possible to control the temperature of the air blown out to the vehicle interior to a suitable heating temperature while dehumidifying the air, and to achieve comfortable and efficient dehumidifying and heating of the vehicle interior.

Incidentally, since the auxiliary heater 23 is disposed on the air upstream side of the radiator 4, the air heated in the auxiliary heater 23 passes through the radiator 4, but the refrigerant is not caused to flow into the radiator 4 in the dehumidifying and heating mode. Hence, there is also eliminated the disadvantage that the radiator 4 absorbs heat from the air heated by the auxiliary heater 23. That is, the temperature of the air blown out to the vehicle interior is suppressed from being lowered by the radiator 4, and a COP is also improved.

(3) Dehumidifying and Cooling Mode

Next, in the dehumidifying and cooling mode, the heat pump controller 32 opens the solenoid valve 17 and closes the solenoid valve 21. Further, the heat pump controller 32 opens the solenoid valve 30 and closes the solenoid valve 40. Then, the heat pump controller 32 operates the compressor 2. The air conditioning controller 20 operates the respective blowers 15 and 27, and the air mix damper 28 basically has a state of passing all the air in the air flow passage 3, which is blown out from the indoor blower 27 and then flows via the heat absorber 9, through the auxiliary heater 23 and the radiator 4 in the heating heat exchange passage 3A, but performs an adjustment of an air volume as well.

Thus, the high-temperature high-pressure gas refrigerant discharged from the compressor 2 flows from the refrigerant pipe 13G into the radiator 4 via the solenoid valve 30. Since the air in the air flow passage 3 passes through the radiator 4, the air in the air flow passage 3 is heated by the high-temperature refrigerant in the radiator 4, whereas the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15, to condense. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B, and flows through the internal heat exchanger 19 to reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence, the air is cooled and dehumidified.

The refrigerant evaporated in the heat absorber 9 flows through the internal heat exchanger 19 to reach the accumulator 12 through the refrigerant pipe 13C, and flows therethrough to be sucked into the compressor 2, thereby repeating this circulation. Since the heat pump controller 32 does not perform energization to the auxiliary heater 23 in the dehumidifying and cooling mode, the air cooled and dehumidified by the heat absorber 9 is reheated (radiation capability being lower than that during the heating) in the process of passing the radiator 4. Thus, the dehumidifying and cooling of the vehicle interior are performed.

The heat pump controller 32 controls the number of revolutions NC of the compressor 2 on the basis of the temperature (the heat absorber temperature Te) of the heat absorber 9 which is detected by the heat absorber temperature sensor 48, and the target heat absorber temperature TEO (transmitted from the air conditioning controller 20) being its target value. Also, the heat pump controller 32 calculates a target radiator pressure PCO from the above-described target heater temperature TCO, and controls the valve position of the outdoor expansion valve 6 on the basis of the target radiator pressure PCO and the refrigerant pressure (the radiator pressure PCI that is a high pressure of the refrigerant circuit R) of the radiator 4 which is detected by the radiator pressure sensor 47 to control heating by the radiator 4.

(4) Cooling Mode

Next, in the cooling mode, the heat pump controller 32 fully opens the valve position of the outdoor expansion valve 6 in the above state of the dehumidifying and cooling mode. Then, the heat pump controller 32 operates the compressor 2 and does not perform energization to the auxiliary heater 23. The air conditioning controller 20 operates the respective blowers 15 and 27, and the air mix damper 28 has a state of adjusting a ratio at which the air in the air flow passage 3 blown out from the indoor blower 27 and passed through the heat absorber 9 is to be passed through the auxiliary heater 23 and the radiator 4 in the heating heat exchange passage 3A.

Consequently, the high-temperature high-pressure gas refrigerant discharged from the compressor 2 flows from the refrigerant pipe 13G into the radiator 4 through the solenoid valve 30, and the refrigerant flowing out from the radiator 4 flows through the refrigerant pipe 13E to reach the outdoor expansion valve 6. At this time, the outdoor expansion valve 6 is fully opened, and hence, the refrigerant passes therethrough and flows into the outdoor heat exchanger 7 as it is, where the refrigerant is air-cooled by the running therein or the outdoor air to pass through the outdoor blower 15, to condense and liquefy. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and reaches the indoor expansion valve 8 through the internal heat exchanger 19. The refrigerant is decompressed in the indoor expansion valve 8 and then flows into the heat absorber 9 to evaporate. The air blown out from the indoor blower 27 is cooled by the heat absorbing operation at this time. Further, the water in the air coagulates to adhere to the heat absorber 9.

The refrigerant evaporated in the heat absorber 9 flows through the internal heat exchanger 19 to reach the accumulator 12 through the refrigerant pipe 13C, and flows therethrough to be sucked into the compressor 2, thereby repeating this circulation. The air cooled and dehumidified in the heat absorber 9 is blown out from the respective outlets 29A through 29C to the vehicle interior (a part thereof passes through the radiator 4 to perform heat exchange), thereby performing the cooling of the vehicle interior. Further, in this cooling mode, the heat pump controller 32 controls the number of revolutions NC of the compressor 2 on the basis of the temperature (the heat absorber temperature Te) of the heat absorber 9 which is detected by the heat absorber temperature sensor 48, and the above-described target heat absorber temperature TEO being its target value.

(5) MAX Cooling Mode (Maximum Cooling Mode)

Next, in the MAX cooling mode as the maximum cooling mode, the heat pump controller 32 opens the solenoid valve 17 and closes the solenoid valve 21. Further, the heat pump controller 32 closes the solenoid valve 30 and opens the solenoid valve 40, and fully closes the valve position of the outdoor expansion valve 6. Then, the heat pump controller 32 operates the compressor 2 and does not perform energization to the auxiliary heater 23. The air conditioning controller 20 operates the respective blowers 15 and 27, and the air mix damper 28 has a state of passing no air in the air flow passage 3 through the auxiliary heater 23 and the radiator 4 in the heating heat exchange passage 3A. However, even if the air is slightly passed, no problem occurs.

Thus, the high-temperature high-pressure gas refrigerant discharged from the compressor 2 to the refrigerant pipe 13G flows into the bypass pipe 35 without flowing to the radiator 4, and reaches the refrigerant pipe 13E on the downstream side of the outdoor expansion valve 6 through the solenoid valve 40. At this time, since the outdoor expansion valve 6 is fully closed, the refrigerant flows into the outdoor heat exchanger 7. The refrigerant flowing into the outdoor heat exchanger 7 is air-cooled by the running therein or the outdoor air to pass through the outdoor blower 15, to condense. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and reaches the indoor expansion valve 8 through the internal heat exchanger 19. The refrigerant is decompressed in the indoor expansion valve 8 and then flows into the heat absorber 9 to evaporate. The air blown out from the indoor blower 27 is cooled by the heat absorbing operation at this time. Further, since the water in the air coagulates to adhere to the heat absorber 9, the air in the air flow passage 3 is dehumidified. A circulation is repeated in which the refrigerant evaporated in the heat absorber 9 flows through the internal heat exchanger 19 to reach the accumulator 12 via the refrigerant pipe 13C, and flows therethrough to be sucked into the compressor 2. At this time, since the outdoor expansion valve 6 is fully closed, it is possible to similarly suppress or prevent the disadvantage that the refrigerant discharged from the compressor 2 reversely flows from the outdoor expansion valve 6 to the radiator 4. Thus, the lowering of a refrigerant circulation amount is suppressed or eliminated to enable an air conditioning capacity to be ensured.

Here, since the high-temperature refrigerant flows into the radiator 4 in the above-described cooling mode, direct heat conduction from the radiator 4 to the HVAC unit 10 occurs in no small way. Since, however, the refrigerant does not flow into the radiator 4 in the MAX cooling mode, the air in the air flow passage 3 from the heat absorber 9 is not heated by the heat transferred from the radiator 4 to the HVAC unit 10. Therefore, the strong cooling of the vehicle interior is performed, and under such an environment that the outdoor air temperature Tam is high in particular, the vehicle interior is rapidly cooled to make it possible to achieve comfortable vehicle interior air conditioning. Further, even in the MAX cooling mode, the heat pump controller 32 controls the number of revolutions NC of the compressor 2 on the basis of the temperature (the heat absorber temperature Te) of the heat absorber 9 which is detected by the heat absorber temperature sensor 48, and the above-described target heat absorber temperature TEO being its target value.

(6) Auxiliary Heater Single Mode

Incidentally, the control device 11 of the embodiment has an auxiliary heater single mode of in the cases such as when excessive frosting occurs in the outdoor heat exchanger 7, etc., stopping the compressor 2 and the outdoor blower 15 in the refrigerant circuit R, and energizing the auxiliary heater 23 to heat the vehicle interior only by the auxiliary heater 23. Even in this case, the heat pump controller 32 controls energization (heat generation) of the auxiliary heater 23 on the basis of the auxiliary heater temperature Tptc detected by the auxiliary heater temperature sensor 50 and the above-described target heater temperature TCO.

Further, the air conditioning controller 20 operates the indoor blower 27, and the air mix damper 28 has a state of passing the air in the air flow passage 3, which is blown out from the indoor blower 27, through the auxiliary heater 23 of the heating heat exchange passage 3A to adjust an air volume. The air heated by the auxiliary heater 23 is blown out from the respective outlets 29A through 29C to the vehicle interior, and hence the heating of the vehicle interior is performed.

(7) Changing of Operation Mode

The air conditioning controller 20 calculates the aforementioned target outlet temperature TAO from the following formula (VI). The target outlet temperature TAO is a target value of the temperature of the air blown out to the vehicle interior.

TAO=(Tset−Tin)×K+Tbal(f(Tset, SUN, Tam)) (VI)

where Tset is a predetermined temperature of the vehicle interior which is set by the air conditioning operating portion 53, Tin is an indoor air temperature detected by the indoor air temperature sensor 37, K is a coefficient, and Tbal is a balance value calculated from the predetermined value Tset, the solar radiation amount SUN detected by the solar radiation sensor 51, and the outdoor air temperature Tam detected by the outdoor air temperature sensor 33. Further, in general, the lower the outdoor air temperature Tam is, the higher the target outlet temperature TAO becomes, and the target outlet temperature TAO is lowered with rising of the outdoor air temperature Tam.

The heat pump controller 32 selects any operation mode from the above respective operation modes on the basis of the outdoor air temperature Tam (detected by the outdoor air temperature sensor 33) and the target outlet temperature TAO transmitted from the air conditioning controller 20 via the vehicle communication bus 65 on startup, and transmits the respective operation modes to the air conditioning controller 20 through the vehicle communication bus 65. Further, after the startup, the heat pump controller 32 changes the respective operation modes on the basis of parameters such as the outdoor air temperature Tam, the humidity of the vehicle interior, the target outlet temperature TAO, a heating temperature TH to be described later, the target heater temperature TCO, the heat absorber temperature Te, the target heat absorber temperature TEO, the presence or absence of a dehumidifying request for the vehicle interior, etc. and thereby appropriately changes the heating mode, the dehumidifying and heating mode, the dehumidifying and cooling mode, the cooling mode, the MAX cooling mode, and the auxiliary heater single mode according to environment conditions or the necessity of the dehumidifying request to control the temperature of the air blown out to the vehicle interior to the target outlet temperature TAO, thereby achieving comfortable and efficient vehicle interior air conditioning.

(8) Control of Compressor 2 in Heating Mode by Heat Pump Controller 32

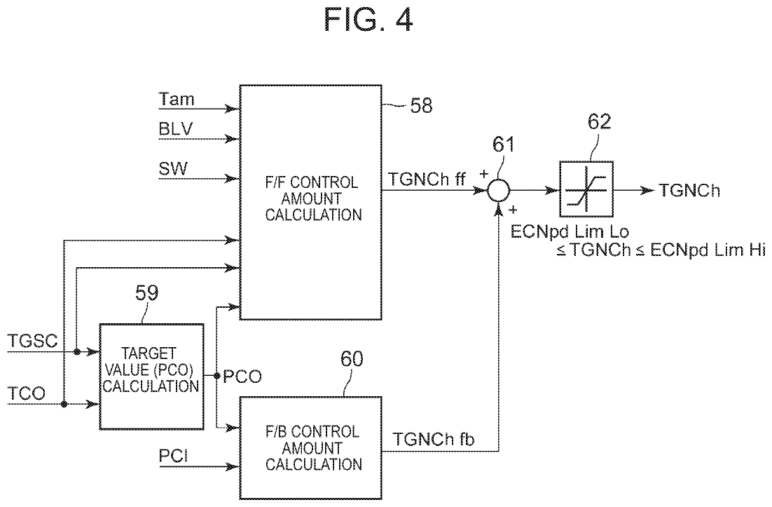

Next, description will be made as to control of the compressor 2 in the aforementioned heating mode in detail using FIG. 4. FIG. 4 is a control block diagram of the heat pump controller 32 which determines a target number of revolutions (a compressor target number of revolutions) TGNCh of the compressor 2 for the heating mode. An F/F (feedforward) control amount calculation section 58 of the heat pump controller 32 calculates an F/F control amount TGNChff of the compressor target number of revolutions on the basis of the outdoor air temperature Tam obtainable from the outdoor air temperature sensor 33, a blower voltage BLV of the indoor blower 27, an air volume ratio SW by the air mix damper 28, which is obtained by SW=(TAO−Te)/(TH−Te), a target subcool degree TGSC that is a target value of a subcool degree SC in the outlet of the radiator 4, the above-mentioned target heater temperature TCO (transmitted from the air conditioning controller 20) that is the target value of the heating temperature TH, and the target radiator pressure PCO that is the target value of the pressure of the radiator 4.

Incidentally, the above TH used to calculate the air volume ratio SW is a temperature (hereinafter called a heating temperature) of the air on the leeward side of the radiator 4 located on the air downstream side of the auxiliary heater 23 in the embodiment. The heat pump controller 32 estimates the TH from a first-order lag calculation formula (VII) shown below:

TH=(INTL×TH0+Tau×THz)/(Tau+INTL) (VII)

where INTL is a calculation period (constant), Tau is a time constant of a first-order lag, TH0 is a steady-state value of the heating temperature TH in a steady state before a first-order lag calculation, and THz is a previous value of the heating temperature TH. Then, the heating temperature TH is transmitted to the air conditioning controller 20 via the vehicle communication bus 65.

The target radiator pressure PCO is calculated by a target value calculation section 59 on the basis of the above-described target subcool degree TGSC and target heater temperature TCO. Further, an F/B (feedback) control amount calculation section 60 calculates an F/B control amount TGNChfb of a compressor target number of revolutions on the basis of the target radiator pressure PCO and the radiator pressure PCI being the refrigerant pressure of the radiator 4. Then, an F/F control amount TGNChff calculated by the F/F control amount calculation section 58 and TGNChfb calculated by the F/B control amount calculation section 60 are added in an adder 61, and its result is added with limits of an upper limit of controlling and a lower limit of controlling in a limit setting section 62, followed by being determined as the compressor target number of revolutions TGNCh. In the heating mode, the heat pump controller 32 controls the number of revolutions NC of the compressor 2 on the basis of the compressor target number of revolutions TGNCh.

(9) Control of Compressor 2 and Auxiliary Heater 23 in Dehumidifying and Heating Mode by Heat Pump Controller 32

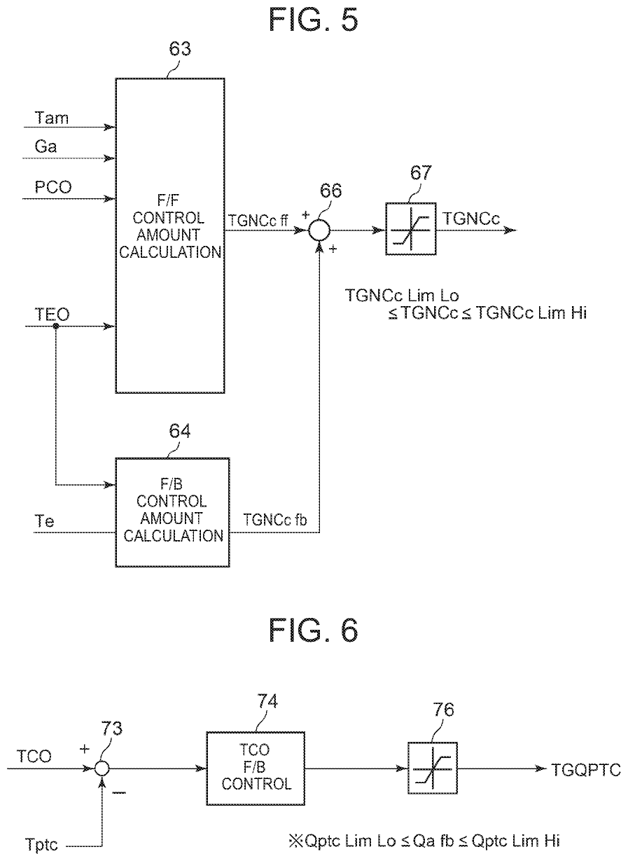

On the other hand, FIG. 5 is a control block diagram of the heat pump controller 32 which determines a target number of revolutions (a compressor target number of revolutions) TGNCc of the compressor 2 for the dehumidifying and heating mode. An F/F control amount calculation section 63 of the heat pump controller 32 calculates an F/F control amount TGNCcff of the compressor target number of revolutions on the basis of the outdoor air temperature Tam, a volumetric air volume Ga of the air flowing into the air flow passage 3, the target radiator pressure PCO being a target value of the pressure (the radiator pressure PCI) of the radiator 4, and the target heat absorber temperature TEO being a target value of the temperature (the heat absorber temperature Te) of the heat absorber 9.

Further, an F/B control amount calculation section 64 calculates an F/B control amount TGNCcfb of the compressor target number of revolutions on the basis of the target heat absorber temperature TEO (transmitted from the air conditioning controller 20), and the heat absorber temperature Te. Then, the F/F control amount TGNCcff calculated by the F/F control amount calculation section 63 and the F/B control amount TGNCcfb calculated by the F/B control amount calculation section 64 are added in an adder 66, and its result is added with limits of an upper limit of controlling and a lower limit of controlling in a limit setting section 67 and then determined as the compressor target number of revolutions TGNCc. In the dehumidifying and heating mode, the heat pump controller 32 controls the number of revolutions NC of the compressor 2 on the basis of the compressor target number of revolutions TGNCc.

Further, FIG. 6 is a control block diagram of the heat pump controller 32 which determines an auxiliary heater required capability TGQPTC of the auxiliary heater 23 in the dehumidifying and heating mode. The target heater temperature TCO and the auxiliary heater temperature Tptc are input to a subtractor 73 of the heat pump controller 32 to calculate a deviation (TCO−Tptc) between the target heater temperature TCO and the auxiliary heater temperature Tptc. The deviation (TCO−Tptc) is input to an F/B control section 74. The F/B control section 74 eliminates the deviation (TCO−Tptc) and calculates an auxiliary heater required capability F/B control amount so that the auxiliary heater temperature Tptc becomes the target heater temperature TCO.

The auxiliary heater required capability F/B control amount calculated in the F/B control section 74 is added with an upper limit of controlling and a lower limit of controlling in a limit setting section 76 and then determined as the auxiliary heater required capability TGQPTC. In the dehumidifying and heating mode, the controller 32 controls energization to the auxiliary heater 23 on the basis of the auxiliary heater required capability TGQPTC to thereby control heat generation (heating) of the auxiliary heater 23 such that the auxiliary heater temperature Tptc becomes the target heater temperature TCO.

Thus, in the dehumidifying and heating mode, the heat pump controller 32 controls the operation of the compressor on the basis of the heat absorber temperature Te and the target heat absorber temperature TEO, and controls the heat generation of the auxiliary heater 23 on the basis of the target heater temperature TCO, thereby appropriately controlling cooling and dehumidifying by the heat absorber 9 and heating by the auxiliary heater 23 in the dehumidifying and heating mode. Consequently, while more adequately dehumidifying the air blown out to the vehicle interior, the temperature of the air can be controlled to a more accurate heating temperature, and more comfortable and efficient dehumidifying and heating of the vehicle interior can be achieved.

(10) Control of Air Mix Damper 28

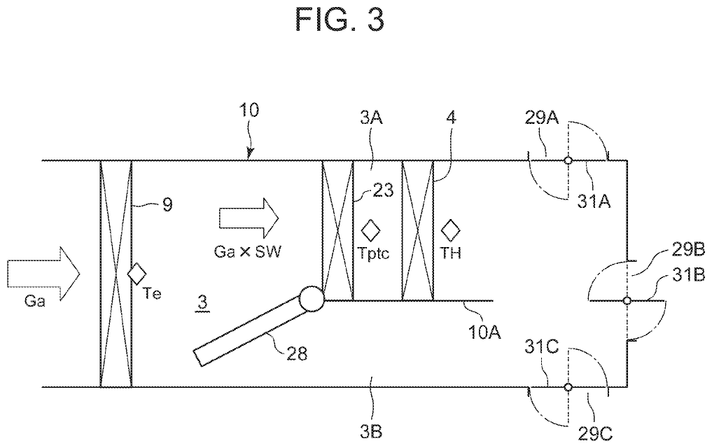

Next, description will be made as to control of the air mix damper 28 by the air conditioning controller 20 while referring to FIG. 3. In FIG. 3, Ga is a volumetric air volume of the air flowing into the above-described air flow passage 3, Te is a heat absorber temperature, and TH is the above-described heating temperature (the temperature of the air on the leeward side of the radiator 4).

On the basis of the air volume ratio SW calculated by the formula (the following formula (I)) and passed through the radiator 4 and the auxiliary heater 23 in the heating heat exchange passage 3A as described above, the air conditioning controller 20 controls the air mix damper 28 so that the air is brought to an air volume of the corresponding ratio, and thereby adjusts an amount of the air passed through the radiator 4 (and the auxiliary heater 23).

SW=(TAO−Te)/(TH−Te) (I)

That is, the air volume ratio SW at which the air is passed through the radiator 4 and the auxiliary heater 23 in the heating heat exchange passage 3A changes within a range of 0≤SW≤1. “0” indicates an air mix fully-closed state in which all the air in the air flow passage 3 is to be passed through the bypass passage 3B without passing it through the heating heat exchange passage 3A, and “1” indicates an air mix fully-opened state in which all the air in the air flow passage 3 is to be passed through the heating heat exchange passage 3A. That is, the air volume to the radiator 4 becomes Ga×SW.

Here, the air conditioning controller 20 controls the respective outlet dampers 31A to 31C to thereby control blowing-out of the air from the respective outlets 29A to 29C. In this case, however, the air conditioning controller 20 has a B/L mode (a first outlet mode) to blow out the air from both outlets of the FOOT outlet 29A and the VENT outlet 29B, and an H/D mode (also being the first outlet mode) to blow out the air from both outlets of the FOOT outlet 29A and the DEF outlet 29C in addition to an outlet mode to blow out the air from any outlet of the FOOT outlet 29A, the VENT outlet 29B, and the DEF outlet 29C (any being the second outlet mode other than the first outlet mode). Then, whether or not any outlet mode is selected is notified from the air conditioning controller 20 to the heat pump controller 32 via the vehicle communication bus 65.

These are selected by manual to the air conditioning operating portion 53 or in an automatic mode, but from that purpose, the FOOT outlet 29A is formed on the heating heat exchange passage 3A side as shown in FIGS. 1 and 3, and is constituted so that the air passed through the heating heat exchange passage 3A (the radiator 4 and the auxiliary heater 23) becomes easy to be blown out from the FOOT outlet 29A. Further, the DEF outlet 29C is formed on the bypass passage 3B side and constituted so that the air passed through the bypass passage 3B becomes easy to be blown out from the DEF outlet 29C. Furthermore, the VENT outlet 29B is formed on the extension of the partition wall 10A and constituted so that the air passed through the bypass passage 3B becomes easy to be blown out from the VENT outlet 29B than from the FOOT outlet 29A, and the air passed through the heating heat exchange passage 3A becomes easy to be blown out therefrom than from the DEF outlet 29C.

Thus, when the aforementioned air volume ratio SW by the air mix damper 28 is in an intermediate range, the temperature of the air blown out from the FOOT outlet 29A becomes higher than the air blown out from the VENT outlet 29B in terms of its temperature, and the temperature of the air blown out from the VENT outlet 29B becomes higher than the air blown out from the DEF outlet 29C in terms of its temperature.

Then, for example, since the air blown out from the VENT outlet 29B is blown out to the proximity of the breast or face of a driver, its temperature is generally preferably about 25° C. (less than the body temperature) from the viewpoint of comfortability, and the temperature of the air blown out from the FOOT outlet 29A is preferably about 40° C. (greater than the body temperature) due to the same reason to blow out the air to the foot. That is, both preferably have a difference of about 15 degs.

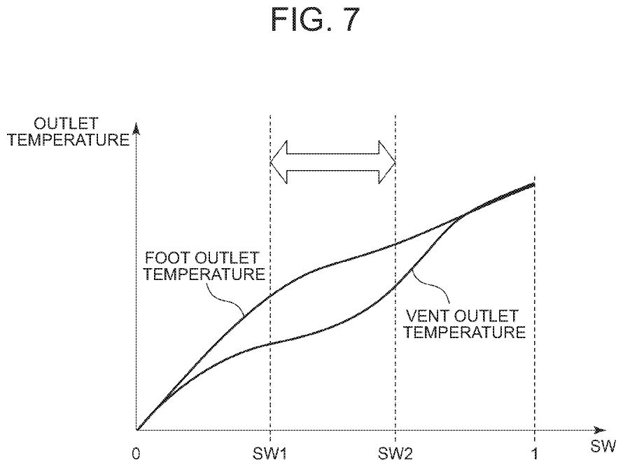

On the other hand, the range of the air volume ratio SW at which it is possible to sufficiently create the difference in outlet temperature between the VENT outlet 29B and the FOOT outlet 29A in the B/L mode, for example is limited although depending on the characteristic of the HVAC unit 10. FIG. 7 shows changes in the respective outlet temperatures (VENT outlet temperature, FOOT outlet temperature) of the VENT outlet 29B and the FOOT outlet 29A when the air volume ratio SW is changed between “1” and “0”. As apparent even from this drawing, the temperature difference can be made in an intermediate range (SW1≤SW≤SW2) between air volume ratios SW1 (e.g., 0.4) and SW2 (e.g., 0.7). This is because the temperatures of the air blown out from the respective outlets 29B and 29A become almost the same even if the air volume ratio SW is too big or too small.

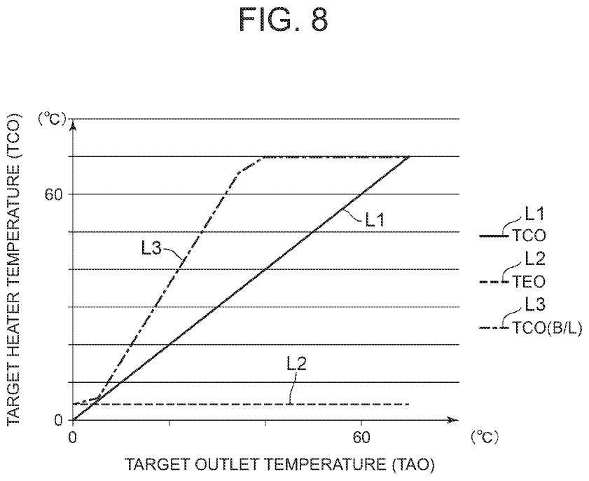

Here, the air conditioning controller 20 has set the aforementioned target heater temperature TCO to TCO=TAO in all outlet modes as indicated by L1 in FIG. 8 in the related art (the target heater temperature TCO calculated by the air conditioning controller 20 is transmitted to the heat pump controller 32 via the vehicle communication bus 65). Incidentally, FIG. 8 shows the relation between the target outlet temperature TAO (horizontal axis) and the target heater temperature TCO (vertical axis). The line L1 of 45° means TCO=TAO. Further, L2 in FIG. 8 indicates the target heat absorber temperature TEO.

Then, since the air volume ratio SW to control the air mix damper 28 is calculated from the above formula (I), for example, the air volume ratio SW is not limited to be in the aforementioned intermediate range (SW1≤SW≤SW2) in the B/L mode, and there also has occurred a situation in which the difference in the outlet temperature between the VENT outlet 29B and the FOOT outlet 29A cannot be made sufficiently.

(11) Calculation Control 1 of Target Heater Temperature TCO in B/L Mode (H/D Mode)

Thus, when the outlet mode is the aforementioned B/L mode (the first outlet mode, and treated similarly even when in the H/D mode), the air conditioning controller 20 of the embodiment sets a predetermined target air volume ratio TGSW to be within the above intermediate range (SW1≤SW≤SW2) of the air volume ratio SW to the radiator 4 and the auxiliary heater 23 in the heating heat exchange passage 3A.

Then, the air conditioning controller calculates a target heater temperature TCO from the following formula (II) on the basis of the aforementioned target outlet temperature TAO and the set target air volume ratio TGSW and transmits it to the heat pump controller 32 via the vehicle communication bus 65.

TCO=(TAO−TEO)/TGSW+TEO (II)

where TEO is the aforementioned target heat absorber temperature.

The above formula (II) is a numerical expression deformed into the form of replacing the heat absorber temperature Te of the formula (I) of calculating the aforementioned air volume ratio SW with the target heat absorber temperature TEO, replacing the air volume ratio SW with the target air volume ratio TGSW, and further replacing the heating temperature TH with the target heater temperature TCO to thereby calculate the target heater temperature TCO. That is, the target heater temperature TCO at which the target air volume ratio TGSW (the value in the intermediate range) can be achieved at the target outlet temperature TAO and the target heat absorber temperature TEO at that time can be calculated from this formula (II).

Here, the target air volume ratio TGSW in the B/L mode (H/D mode) is set to and stored in the air conditioning controller 20 in advance within the aforementioned intermediate range (SW1≤SW≤SW2) of air volume ratio SW. In this case, the target air volume ratio TGSW to be set thereto may be fixed in all the operation modes. Any values (optimal values at each of which the difference in temperature between the aforementioned outlet and the outlet thereabove can be made) in the intermediate range optimal to those are respectively determined in advance by experiments according to the respective operation modes, and may be set to the air conditioning controller 20.

Since the air volume ratio SW changes in a range of 0≤SW≤1, for example, the above formula (II) can be simplified into the following formula (III) where, for example, the target air volume ratio TGSW is set to 0.5 (a value serving as the center of 0 to 1) in the aforementioned intermediate range (SW1≤SW≤SW2) in advance.

TCO=2×TAO−TEO (III)

The target heater temperature TCO calculated in this formula (III) is indicated by L3 in FIG. 8. It is understood from FIG. 8 that as compared with the case of TCO=TAO, the target heater temperature TCO calculated in the formula (III) shows a change in which it steeply rises from a region in which the target outlet temperature TAO is low, and becomes approximately constant in a region in which the target outlet temperature TAO is high.

The heat pump controller 32 having received the so-calculated target heater temperature TCO controls the compressor 2 from the region in which the target outlet temperature TAO is low, in the heating mode, for example to increase a heating capability by the radiator 4 and enhance a heating capability by the auxiliary heater 23 from the region in which the target outlet temperature TAO is low, similarly in the dehumidifying and heating mode. The heat pump controller controls the outdoor expansion valve 6 from the region in which the target outlet temperature TAO is low, similarly in the dehumidifying and cooling mode to increase the heating capability by the radiator 4 and enhance the heating capability by the auxiliary heater 23 in the auxiliary heater single mode. It is thus possible to compensate and maintain a reduction in the outlet temperature while setting the air volume ratio SW to the intermediate range (SW1'SW≤SW2, and L3 in FIG. 8 is TGSW=0.5). This applies to the H/D mode too.

Thus, in the present invention, the air conditioning controller 20 sets the predetermined target air volume ratio TGSW to be within the predetermined intermediate range of the air volume ratio SW in the B/L mode (similarly even in the H/D mode) and calculates the target heater temperature TCO on the basis of the target outlet temperature TAO and the target air volume ratio TGSW. Therefore, in the B/L mode (H/D mode), the target heater temperature TCO at which the air volume ratio SW calculated from the target outlet temperature TAO and the heating temperature TH falls within the predetermined intermediate range, is calculated from the target outlet temperature TAO and the target air volume ratio TGSW, and the heating by the radiator 4 and the auxiliary heater 23 is controlled by the heat pump controller 32 on the basis of the calculated target heater temperature TCO.

Thus, while maintaining the outlet temperature of the air to the vehicle interior, a sufficient difference in temperature is made between the air blown out from the FOOT outlet 29A and the air blown out from the VENT outlet 28B in the B/L mode, and a sufficient difference in temperature is made between the air blown out from the FOOT outlet 29A and the air blown out from the DEF outlet 29C in the H/D mode, thereby making it possible to smoothly realize comfortable vehicle interior air conditioning indicative of so-called “head-cold/feet-warm. In the embodiment in particular, since the target heater temperature TCO is calculated in the above-described formulas (II) and (III), the appropriate calculation of target heater temperature TCO can be performed.

Further, the present invention is extremely effective for the vehicle air-conditioning device 1 which is provided with the radiator 4 for letting the refrigerant radiate heat to thereby heat the air to be supplied from the air flow passage 3 to the vehicle interior, and the auxiliary heater 23 for heating the air to be supplied from the air flow passage 3 to the vehicle interior as in the embodiment to heat either one of these or both thereof.

(12) Calculation Control 2 of Target Heater Temperature TCO in B/L Mode (H/D Mode)

Incidentally, the target air volume ratio TGSW may be determined from the following formula (IV) by using the heat absorber temperature Te instead of the target heat absorber temperature TEO.

TCO=(TAO−Te)/TGSW+Te (IV)

The above formula (IV) is a numerical expression deformed into the form of replacing the air volume ratio SW of the formula (I) of calculating the aforementioned air volume ratio SW with the target air volume ratio TGSW, and replacing the heating temperature TH with the target heater temperature TCO to thereby calculate the target heater temperature TCO.

Then, even in this case, when the outlet mode is the aforementioned B/L mode (the first outlet mode, and treated similarly even when in the H/D mode), the air conditioning controller 20 sets a predetermined target air volume ratio TGSW to be within the above intermediate range (SW1≤SW≤SW2) of the air volume ratio SW to the radiator 4 and the auxiliary heater 23 in the heating heat exchange passage 3A. The target heater temperature TCO at which the target air volume ratio TGSW (the value in the intermediate range) can be achieved at the target outlet temperature TAO and the heat absorber temperature Te at that time can be calculated even by this formula (IV).

Even in this case, since the air volume ratio SW changes in the range of 0≤SW≤1 as described above, the above formula (IV) can be simplified into the following formula (V) where, for example, TGSW is set to 0.5 (the value serving as the center of 0 to 1) in the aforementioned intermediate range (SW1≤SW≤SW2) in advance.

TCO=2×TAO−Te (V)

The heat pump controller 32 having received the so-calculated target heater temperature TCO controls the compressor 2 from the region in which the target outlet temperature TAO is low, in the heating mode similarly to increase the heating capability by the radiator 4 and enhance the heating capability by the auxiliary heater 23 from the region in which the target outlet temperature TAO is low, similarly in the dehumidifying and heating mode and the auxiliary heater single mode, and controls the outdoor expansion valve 6 from the region in which the target outlet temperature TAO is low, similarly in the dehumidifying and cooling mode to increase the heating capability by the radiator 4.

Thus, while maintaining the outlet temperature of the air to the vehicle interior, the air volume ratio SW is set to the intermediate range (SW1≤SW≤SW2). Further, a sufficient difference in temperature is made between the air blown out from the FOOT outlet 29A and the air blown out from the VENT outlet 29B in the B/L mode, and a sufficient difference in temperature is made between the air blown out from the FOOT outlet 29A and the air blown out from the DEF outlet 29C in the H/D mode, thereby making it possible to smoothly realize comfortable vehicle interior air conditioning indicative of a so-called “head-cold/feet-warm. Further, even in the case of the embodiment, since the target heater temperature TCO is calculated in the above-described formulas (IV) and (V), the appropriate calculation of target heater temperature TCO can be performed.

### Embodiment 2

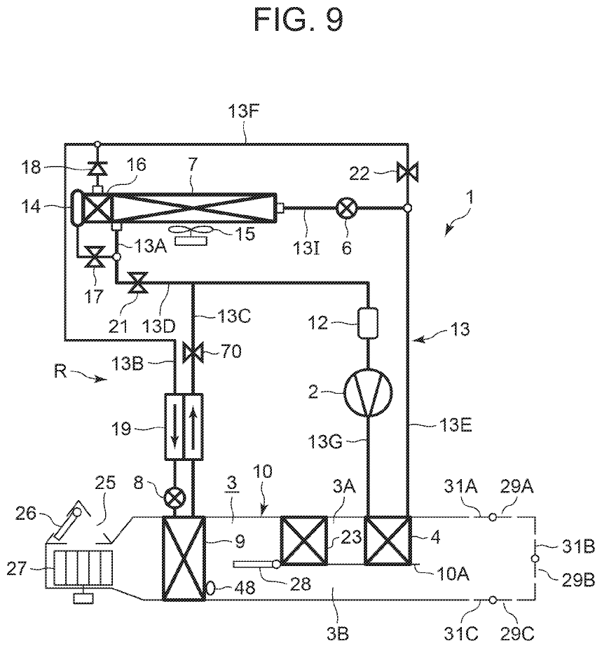

Next, FIG. 9 shows a constitutional view of a vehicle air-conditioning device 1 of another embodiment to which the present invention is applied. Incidentally, in this drawing, components denoted at the same reference numerals as those in FIG. 1 have the same or similar function. In the case of the present embodiment, an outlet of a subcooling portion 16 is connected to a check valve 18. An outlet of the check valve 18 is connected to a refrigerant pipe 13B. Incidentally, the check valve 18 has a refrigerant pipe 13B (an indoor expansion valve 8) side which serves as a forward direction.

Further, a refrigerant pipe 13E on an outlet side of a radiator 4 branches before an outdoor expansion valve 6, and this branching refrigerant pipe (hereinafter called a second bypass pipe) 13F communicates and connects with the refrigerant pipe 13B on a downstream side of the check valve 18 via a solenoid valve 22 (for dehumidification). Additionally, an evaporation pressure control valve 70 is connected to a refrigerant pipe 13C on an outlet side of a heat absorber 9 on a refrigerant downstream side of an internal heat exchanger 19 and on a refrigerant upstream side than a joining point with a refrigerant pipe 13D. Then, these solenoid valve 22 and evaporation pressure control valve 70 are also connected to an output of a heat pump controller 32. Further, the bypass device 45 constituted of the bypass pipe 35, the solenoid valve 30 and the solenoid valve 40 in FIG. 1 of the aforementioned embodiment is not provided. Since others are similar to those in FIG. 1, their description will be omitted.

With the above constitution, an operation of the vehicle air-conditioning device 1 of this embodiment will be described. In this embodiment, the heat pump controller 32 changes and executes respective operation modes of a heating mode, a dehumidifying and heating mode, an internal cycle mode, a dehumidifying and cooling mode, and a cooling mode (a MAX cooling mode does not exist in this embodiment). Incidentally, since operations and a flow of a refrigerant at the time that the heating mode, the dehumidifying and cooling mode, and the cooling mode are selected are similar to those in the case of the aforementioned embodiment (Embodiment 1), their description will be omitted. In the present embodiment (Embodiment 2), however, the solenoid valve 22 is assumed to be closed in these heating mode, dehumidifying and cooling mode and cooling mode.

(13) Dehumidifying and Heating Mode of Vehicle Air-Conditioning Device 1 in FIG. 9

On the other hand, when the dehumidifying and heating mode is selected, the heat pump controller 32 opens a solenoid valve 21 (for the heating) and closes a solenoid valve 17 (for the cooling) in this embodiment (embodiment 2). Also, the heat pump controller 32 opens the solenoid valve 22 (for the dehumidification). Then, the heat pump controller 32 operates a compressor 2. An air conditioning controller 20 operates respective blowers 15 and 27, and an air mix damper 28 basically has a state of passing all the air in an air flow passage 3, which is blown out from the indoor blower 27 and then flows via the heat absorber 9, through an auxiliary heater 23 and a radiator 4 in a heating heat exchange passage 3A, but performs an air volume adjustment as well.

Consequently, a high-temperature high-pressure gas refrigerant discharged from the compressor 2 flows from a refrigerant pipe 13G into the radiator 4. Since the air in the air flow passage 3 flowing into the heating heat exchange passage 3A passes through the radiator 4, the air in the air flow passage 3 is heated by the high-temperature refrigerant in the radiator 4, whereas the refrigerant in the radiator 4 has the heat taken by the air and is cooled to condense and liquefy.

The refrigerant liquefied in the radiator 4 flows out from the radiator 4 and then reaches the outdoor expansion valve 6 through the refrigerant pipe 13E. The refrigerant flowing into the outdoor expansion valve 6 is decompressed therein, and then flows into an outdoor heat exchanger 7. The refrigerant flowing into the outdoor heat exchanger 7 evaporates, and the heat is pumped up from the outdoor air passed by running or the outdoor blower 15. In other words, a refrigerant circuit R functions as a heat pump. Then, a circulation is repeated in which the low-temperature refrigerant flowing out from the outdoor heat exchanger 7 flows via a refrigerant pipe 13A, the solenoid valve 21, and the refrigerant pipe 13D from the refrigerant pipe 13C into an accumulator 12, where it is subjected to gas-liquid separation, and then the gas refrigerant is sucked into the compressor 2.

Further, a part of the condensed refrigerant flowing to the refrigerant pipe 13E through the radiator 4 is distributed and flows through the solenoid valve 22 to reach from the second bypass pipe 13F and the refrigerant pipe 13B to the indoor expansion valve 8 through the internal heat exchanger 19. The refrigerant is decompressed by the indoor expansion valve 8 and then flows into the heat absorber 9 to evaporate. The water in the air blown out from the indoor blower 27 coagulates to adhere to the heat absorber 9 by a heat absorbing operation at this time, and hence, the air is cooled and dehumidified.

A circulation is repeated in which the refrigerant evaporated in the heat absorber 9 joins the refrigerant from the refrigerant pipe 13D at the refrigerant pipe 13C through the internal heat exchanger 19 and the evaporation pressure control valve 70, and is then sucked into the compressor 2 through the accumulator 12. The air dehumidified in the heat absorber 9 is reheated in the process of passing through the radiator 4, and hence the dehumidifying and heating of the vehicle interior are performed.

The air conditioning controller 20 transmits a target heater temperature TCO (a target value of a heating temperature TH) calculated from a target outlet temperature TAO to the heat pump controller 32. The heat pump controller 32 calculates a target radiator pressure PCO (a target value of a radiator pressure PCI) from the target heater temperature TCO and controls the number of revolutions NC of the compressor 2 on the basis of the target radiator pressure PCO and a refrigerant pressure (a radiator pressure PCI that is a high pressure of the refrigerant circuit R) of the radiator 4 which is detected by a radiator pressure sensor 47 to control heating by the radiator 4. Further, the heat pump controller 32 controls a valve position of the outdoor expansion valve 6 on the basis of a temperature Te of the heat absorber 9 which is detected by a heat absorber temperature sensor 48, and a target heat absorber temperature TEO transmitted from an air conditioning controller 20. Additionally, the heat pump controller 32 opens (to enlarge a flow path)/closes (to allow small refrigerant to flow) the evaporation pressure control valve 70 on the basis of the temperature Te of the heat absorber 9 detected by the heat absorber temperature sensor 48 to prevent inconvenience that the heat absorber 9 is frozen due to an excessive drop of its temperature.

(14) Internal Cycle Mode of Vehicle Air-Conditioning Device 1 of FIG. 9

Further, in the internal cycle mode, the heat pump controller 32 fully closes the outdoor expansion valve 6 in a state of the above dehumidifying and heating mode (fully closed position) and closes the solenoid valve 21. With the closure of the outdoor expansion valve 6 and the solenoid valve 21, the inflow of the refrigerant into the outdoor heat exchanger 7, and the outflow of the refrigerant from the outdoor heat exchanger 7 are prevented, and hence the condensed refrigerant flowing into the refrigerant pipe 13E through the radiator 4 all flows into the second bypass pipe 13F through the solenoid valve 22. Then, the refrigerant flowing through the second bypass pipe 13F reaches from the refrigerant pipe 13B to the indoor expansion valve 8 through the internal heat exchanger 19. The refrigerant is decompressed by the indoor expansion valve 8 and then flows into the heat absorber 9 to evaporate. The water in the air blown out from the indoor blower 27 coagulates to adhere to the heat absorber 9 by a heat absorbing operation at this time, and hence, the air is cooled and dehumidified.

A circulation is repeated in which the refrigerant evaporated in the heat absorber 9 flows into the refrigerant pipe 13C through the internal heat exchanger 19 and the evaporation pressure control valve 70 and is sucked into the compressor 2 through the accumulator 12. The air dehumidified in the heat absorber 9 is reheated in the process of passing through the radiator 4, and hence the dehumidifying and heating of the vehicle interior are performed. Since, however, the refrigerant is circulated between the radiator 4 (heat radiation) and the heat absorber 9 (heat absorption) lying in the air flow passage 3 on the indoor side in the internal cycle mode, the pumping up of heat from the outdoor air is not performed, and a heating capability corresponding to power consumption of the compressor 2 is exhibited. Since the whole amount of the refrigerant flows through the heat absorber 9 which exhibits a dehumidifying operation, a dehumidifying capability is high as compared with the above dehumidifying and heating mode, but the heating capability becomes low.

The air conditioning controller 20 transmits the target heater temperature TCO (the target value of the heating temperature TH) calculated from the target outlet temperature TAO to the heat pump controller 32. The heat pump controller 32 calculates a target radiator pressure PCO (a target value of the radiator pressure PCI) from the transmitted target heater temperature TCO, and controls the number of revolutions NC of the compressor 2 on the basis of the target radiator pressure PCO and the refrigerant pressure (the radiator pressure PCI that is the high pressure of the refrigerant circuit R) of the radiator 4 detected by the radiator pressure sensor 47 to control heating by the radiator 4.

Even in the vehicle air-conditioning device 1 like this embodiment, (11) the calculation control 1 of the target heater temperature TCO in the B/L mode (H/D mode), and (12) the calculation control 2 of the target heater temperature TCO in the B/L mode (H/D mode) are executed in the heating mode, the dehumidifying and heating mode, the internal cycle mode, the dehumidifying cooling mode, and the auxiliary heater single mode, thereby making it possible to make the sufficient difference in temperature between the air blown out from the FOOT outlet 29A and the air blown out from the VENT outlet 29B in the B/L mode or the like, whereby comfortable vehicle interior air conditioning of so-called “head-cold/feet-warm” can be realized.

Incidentally, in each embodiment, the B/L mode and the H/D mode have been adopted as the first outlet mode, but are not limited thereto. There is also considered a case in which the air is blown out from both of the VENT outlet 29B and the DEF outlet 29C in terms of the first outlet mode.

Further, the changing control of the respective operation modes shown in the embodiment is not limited thereto. Any of parameters such as the outdoor air temperature Tam, the humidify of the vehicle interior, the target outlet temperature TAO, the heating temperature TH, the target heater temperature TCO, the heat absorber temperature Te, the target heat absorber temperature TEO, the presence or absence of the request for dehumidification of the vehicle interior, etc., or their combination, or all of them may be adopted to set appropriate conditions.

Further, the auxiliary heating device is not limited to the auxiliary heater 23 shown in the embodiment, but may utilize a heating medium circulating circuit of circulating a heating medium heated by a heater to heat air in the air flow passage 3, a heater core of circulating radiator water heated by an engine, etc.

### DESCRIPTION OF REFERENCE NUMERALS

1 vehicle air-conditioning device

2 compressor

3 air flow passage

3A heating heat exchange passage

3B bypass passage

4 radiator (heater)

6 outdoor expansion valve

7 outdoor heat exchanger

8 indoor expansion valve

9 heat absorber

10 HVAC unit

10A partition wall

11 control device

20 air conditioning controller

23 auxiliary heater (auxiliary heating device, heater)

27 indoor blower (blower fan)

28 air mix damper

29A FOOT outlet (first outlet)

29B VENT outlet (second outlet, first outlet)

29C DEF outlet (second outlet)

31A-31C outlet damper

32 heat pump controller

65 vehicle communication bus

R refrigerant circuit

1. A vehicle air-conditioning device comprising:
a compressor to compress a refrigerant;
an air flow passage through which air to be supplied to a vehicle interior flows;
a heater to heat the air to be supplied from the air flow passage to the vehicle interior;
a heat absorber to let the refrigerant absorb heat, thereby cooling the air to be supplied from the air flow passage to the vehicle interior;
a heating heat exchange passage and a bypass passage partitioned and formed in the air flow passage on a leeward side than the heat absorber;
an air mix damper to adjust a ratio at which the air in the air flow passage passed through the heat absorber is to be passed through the heating heat exchange passage;
a first outlet to blow out the air from the air flow passage to the vehicle interior;
a second outlet to blow out the air from the air flow passage to the vehicle interior at a position above the first outlet; and
a control device,
wherein the heater is disposed in the heating heat exchange passage, and the vehicle air-conditioning device is configured so that the air passed through the heating heat exchange passage is easy to be blown out from the first outlet than the second outlet and the air passed through the bypass passage is easy to be blown out from the second outlet than the first outlet,
wherein the control device controls heating by the heater on the basis of a target heater temperature TCO being a target value of a heating temperature TH being a temperature of the air on a leeward side of the heater,
wherein the control device calculates an air volume ratio SW of the air to be passed through the heating heat exchange passage on the basis of a target outlet temperature TAO being a target value of a temperature of the air blown out to the vehicle interior and the heating temperature TH to control the air mix damper,
wherein the control device has a first outlet mode to blow out the air from both of the first outlet and the second outlet to the vehicle interior, and
wherein in the first outlet mode, the control device sets a predetermined target air volume ratio TGSW to be within a predetermined intermediate range of the air volume ratio SW, and calculates the target heater temperature TCO on the basis of the target outlet temperature TAO and the target air volume ratio TGSW.

2. The vehicle air-conditioning device according to claim 1, wherein when it is given that SW=(TAO−Te)/(TH−Te) . . . (I),
where a temperature of the heat absorber is assumed to be Te, the control device calculates the air volume ratio SW in the above formula (I).

3. The vehicle air-conditioning device according to claim 2, wherein when it is given that
TCO=(TAO−TEO)/TGSW+TEO (II),
where a target heat absorber temperature being a target value of the temperature Te of the heat absorber is assumed to be TEO, the control device calculates the target heater temperature TCO in the above formula (II).

4. The vehicle air-conditioning device according to claim 3, wherein when it is given that TCO=2×TAO−TEO . . . (III),
the control device calculates the target heater temperature TCO in the above formula (III).

5. The vehicle air-conditioning device according to claim 2, wherein when it is given that TCO=(TAO−Te)/TGSW+Te . . . (IV), the control device calculates the target heater temperature TCO in the above formula (IV).

6. The vehicle air-conditioning device according to claim 5, wherein when it is given that TCO=2×TAO−Te . . . (V),
the control device calculates the target heater temperature TCO in the above formula (V).

7. The vehicle air-conditioning device according to claim 1, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.

8. The vehicle air-conditioning device according to claim 2, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.

9. The vehicle air-conditioning device according to claim 3, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.

10. The vehicle air-conditioning device according to claim 4, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.

11. The vehicle air-conditioning device according to claim 5, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.

12. The vehicle air-conditioning device according to claim 6, wherein the heater is a radiator to let the refrigerant radiate heat to thereby heat the air to be supplied from the air flow passage to the vehicle interior, and/or an auxiliary heating device to heat the air to be supplied from the air flow passage to the vehicle interior.
